(19) United States
(12) Patent Application Publication
(10) Pub. No.: US 2016/0020909 A1
(43) Pub. Date: Jan. 21, 2016

(54) A METHOD, A SYSTEM, A COMPUTER SYSTEM AND A COMPUTER PROGRAM PRODUCT FOR CERTIFYING A PROCEDURE OF SIGNATURE OF AN ELECTRONIC FILE RELATING TO AN AGREEMENT BETWEEN AT LEAST TWO PARTIES

(71) Applicant: Manuel GARDEÑES LIÑAN, (US)

(72) Inventor: Manuel GARDEÑES LIÑAN, Castelldefels (ES)

(21) Appl. No.: 14/775,463

(22) PCT Filed: Mar. 11, 2013
(86) PCT No.: PCT/EP2013/054915

§ 371 Date: Sep. 11, 2015

(51) Int. Cl. H04L 9/32; H04L 9/08

(52) U.S. Cl. CPC H04L 9/3247; H04L 9/3263; H04L 9/0825; H04L 9/3297

(57) ABSTRACT

The invention relates to a method of certifying a procedure of signature of an electronic file relating to an agreement between at least two parties, the method comprising providing an electronic file relating to an agreement between at least two parties; and when acceptance data of the agreement is received from at least one party the method further comprises digitally signing the agreement electronic file by generating an electronic fingerprint of said agreement electronic file; creating a certification file comprising at least the agreement electronic file and the generated electronic fingerprint of said agreement electronic file; processing at least the certification file.

The present invention relates to a method for certifying a procedure of signature of an electronic file relating to an agreement between at least two parties.

The invention also relates to a system, a computing system and a computer program product suitable for carrying out such a method.

### BACKGROUND ART

Nowadays, electronic documents are used for any type of operations between different parties (e.g. agreement electronic files), complementing or replacing paper documents. Whenever such electronic documents are used for any type of legal transaction, these usually require a signature, as with paper documents.

We can consider five types of operations relating to legal transaction or operations requiring legal validity:
1) In person with a notary: it can be done in the presence of a notary. It requires that all parties (vendor, customer and notary) be at the same place at the same time. In this case, it is important to highlight that the notary is a public commissioner but he/she is not an expert in any specific subject. So, he/she can only say when and who signed the contract.
2) In person without a notary: this scenario is weaker than the previous. In this case only the contracting parties (e.g. vendor and customer) must be at the same place at the same time. There is no independent third party to attest to whom, when and how the contract was signed.
3) Remotely through the web or when agreeing to a software license: this scenario is even weaker than the two previous ones. The customer is invited to check a tick box and/or to click on a button to accept the terms and conditions of the contract. Very often, practically always, the customer checks the tick box or clicks on the button without previously reading the contract.
4) Remotely by fax or email: the vendor sends the contract by fax or email and requests the customer to sign it and to return a scanned copy by fax or by email. The signatures received by the vendor are not originals, which may lead to doubts about their authenticity. It introduces a delay in the contracting process which may lead to discontinuity or cancelation of the contract.
5) Remotely by post: the vendor sends the contract by post and requires to the customer to sign it and to return it signed by post. There is no record of the sales process itself. It may create conflicts about possible falsifications. It introduces a long delay in the contracting process which may lead to discontinuity or cancelation of the contract

On the other hand, the Internet has enabled many transactions and electronic contracts to be digitised and to be concluded online.

Fundamentally, electronic contracts involve the use of remote communications and therefore necessitate all parties involved to authenticate one another. One of the primary technologies proposed for authentication is electronic signature technology of which a claimed advantage is “non-repudiation”. Some commentators have gone so far as to advocate that if the electronic signature is verified then the owner of the private key is prevented from repudiating the electronic signature.

However, it is easily possible for many electronic methods of signature to forge assent. The rapidly rising problem of identity theft illustrates the ease of such forgeries. Electronic signatures may be stolen by intercepting emails containing the electronic signature prior to applying it. They may also be obtained through human carelessness. Fraud is a common issue in all signature situations, and neither type of signature, paper or electronic, provides fully effective anti-fraud protections.

In the paper-based environment there exists a universal trust mechanism established to overcome a false claim of non-repudiation. This trust mechanism is the witnessing of the signing process. Witnessing simply occurs at the time the signature is being affixed. That is, by having an independent adult witness the signing of a document reduces the ability of the signatory to successfully deny the signature as a forgery at a later date. It is always open for the signatory to deny the signature on other grounds such as:
The signature is a forgery;
The signature is not a forgery, but was obtained via:
   Unconscionable conduct by a party to a transaction;
   Fraud instigated by a third party;
   Undue influence exerted by a third party;
The signature is not a forgery, but the signing party was mentally incompetent or mentally incapacitated or intoxicated;
The signature is not a forgery, but the terms of the service themselves were unreasonable in content, length or complexity or in a foreign language which lead to the signatory inability to understand the terms of the service.

The electronic commerce environment should not have different rules from those developed over many centuries in the paper-based environment. These rules have been developed and judicially tested so as not to disadvantage any party in a transaction. There is a clear contradictory position between the technical meaning and the legal meaning of the term “non-repudiation” where there is a clear case of forgery as regards to an alleged electronic signature.

In the traditional legal sense, the onus of proof in a case involving a forged paper-based signature lies upon the party wishing to rely upon the signature.

The relying party in relation to an alleged forged signature is required to establish that the signature is not a forgery.

If the alleged signatory disputes the signature as belonging to him/her then the onus falls upon the relying party to prove that the signature is in fact that of the alleged signatory.

On the other hand, in the electronic commerce environment, the technical meaning of the term “non-repudiation” either shifts the onus of proof from the recipient to the alleged signatory or entirely denies the signatory the right to repudiate an electronic signature. That is, if an electronic signature is verified so as to identify the owner of the private key that was used to create the electronic signature in question then it is that person who has the onus of proving that it is not their electronic signature. Hence, there is a shift in the burden of proof. This technical position does not correspond with what occurs in the paper-based environment.

Consequently, what is needed are methods, systems, computing systems and computer program products for certifying a procedure of signature of an electronic file, resulting in non-repudiable and non-alterable evidence without disadvantaging any party in a transaction.

### SUMMARY OF THE INVENTION

It is an object of the present invention to provide a method of certifying a procedure of signature of an electronic file relating to an agreement between at least two parties, which avoids the disadvantages described by the prior art.

To achieve the above, according to a first aspect, it is provided a method for certifying a procedure of signature of an electronic file relating to an agreement between at least two parties, the method comprising:
Providing an electronic file relating to an agreement between at least two parties;
   when acceptance data of the agreement is received from at least one party:
Digitally signing the agreement electronic file by generating an electronic fingerprint of said agreement electronic file;
Creating a certification file comprising at least the agreement electronic file and the generated electronic fingerprint of said agreement electronic file;
Processing at least the certification file.

This way, the obtained certification file of the procedure of signature is cryptographically sealed and saved in a digital format for future use as evidence of said procedure of signature, said certification file being an irrefutable proof of the formalization of the procedure of signature of the agreement.

Basically, when at least one party sends acceptance data of the agreement, the agreement electronic file is digitally signed by generating an electronic fingerprint of it. Then, a certification file comprising the agreement electronic file and its associated electronic fingerprint is created and processed for making the certification file available to the parties signing the agreement.

An agreement electronic file in the context of this invention usually refers to an electronic file that captures the terms and conditions of the agreement. The agreement is not limited to a text only format and may be, for example, a multimedia file previously generated or generated during the procedure of signature. The agreement most often will be written as an electronic document using a computer or a computing system. However, the agreement electronic file may also be a hand written document that is subsequently scanned into the computer or the computing system. It may also be an audio or video file in which the terms and conditions of the agreement are only stated or expressed verbally or visually, for example in the case of using sign language. The multimedia file may optionally be transcribed at a later time or date for ease of reference and future data search.

The generated electronic fingerprint of the agreement electronic document is unique and ensures that the agreement electronic file has not been modified. More specifically, the electronic fingerprint of the agreement electronic file may comprise a cryptographic hash value that may be obtained by applying a cryptographic hash function to a consistent version of the agreement electronic file. The expression “consistent version” refers to a format of the agreement electronic file that always produces the same hash value when applying the same cryptographic hash function.

A cryptographic hash function is a deterministic procedure that takes an arbitrary block of data and returns a fixed-size bit string, the (cryptographic) hash value, such that an accidental or intentional change to the data will change the hash value. The data to be encoded (i.e. inputted to the hash function) is often called the “message” and the hash value (i.e. the output of the hash function applied to the “message”) is normally called message digest or simply digest.

A hash function that may be used is the SHA-256 (a universal cryptography algorithm from the United States National Security Agency (NSA/CSS)) that belongs to the standard SHA-2 cryptographic hash functions set, although another hash function may be used if e.g. it is demonstrated in the future that SHA-256 is not secure enough. For example, SHA-1 and MD5 where initially considered in the context of this invention, but they were finally discarded due to some reported security flaws.

The security of a hash function is determined by its resistance to collisions. A hash function is collision resistant if its application to different messages (data to be encoded) produces different message digest. Even though SHA-256 is currently used in the context of this invention (the probability of collision for said hash function is approximately 1 to 10¹⁵ whereas the probability that a given file will generate two different hash codes is zero), it could be substituted in the future by another hash function with improved resistance to collisions (i.e. more secure), such as e.g. SHA-3, which is a new hash standard currently under development at the time of this patent application.

A “consistent version” of the agreement electronic file may be obtained e.g. by generating a PDF file from this agreement file. Portable Document Format (PDF) is an open standard for document exchange. This file format, created by Adobe Systems, is used for representing documents in a manner independent of application software, hardware, and operating systems. Therefore, different executions of the same cryptographic hash function on a PDF representing the same agreement electronic file are supposed to produce the same hash value.

Therefore, generating an electronic fingerprint of the agreement document file may comprise applying a cryptographic hash function to a PDF file generated from said agreement document file. This PDF file may be obtained by e.g. printing the agreement document file to a PDF virtual printer.

Further, a “consistent version” of the agreement electronic file may also be obtained by means of an Open XML Paper Specification (also referred to as OpenXPS). OpenXPS is an open specification for a page description language and a fixed-document format originally developed by Microsoft as XML Paper Specification (XPS). It is an XML-based specification, based on a new print path and a color-managed vector-based document format that supports device independence and resolution independence.

According to an embodiment, creating a certification file comprising the agreement electronic file and its associated electronic fingerprint may comprise:
Giving the agreement electronic file a name based on its associated electronic fingerprint;
   wherein the certification file comprises the agreement electronic file and its associated electronic fingerprint as a renamed file.

This way, the certification file comprises the agreement electronic file and its associated electronic fingerprint, said electronic fingerprint being the name of the agreement electronic file.

Alternatively, creating a certification file comprising the agreement electronic file and its associated electronic fingerprint may comprise:
Creating a packed file (e.g. a compressed file or an encrypted file) comprising the agreement electronic file and its associated electronic fingerprint file;
   wherein the certification file comprises the agreement electronic file and its associated electronic fingerprint file as a packed file. Previous to create the packed file it is required to create a file comprising the generated electronic fingerprint of the agreement electronic file.

It is important to highlight that all described files (e.g. the agreement electronic file, the electronic fingerprint file, the certification file) may be stored in a repository of certification data. A unique identifier of the procedure of signature of the agreement may be generated and the described files may be stored in the repository of certification data, associated to said unique identifier. With reference to the unique identifier of the procedure of signature of the agreement, it may have the form of an alphanumeric string. If the repository of certification data is a relational database, the unique identifier may be the primary key of the database.

In an embodiment of the invention, the method may comprise:
Obtaining a timestamp relating to the procedure of signature of the agreement for the agreement electronic file;
Adding the obtained timestamp to the agreement electronic file, before signing said agreement electronic file.

Obtaining a timestamp and adding said timestamp to the agreement electronic file before signing it further reinforces the irrefutable proof of the formalization of the procedure of signature of the agreement. Any modification of the timestamp will result in an irreversible change in the original electronic fingerprint associated to the agreement electronic file.

The aim of the obtained timestamp token is to establish the precise date and time at which the agreement electronic file is digitally signed. This timestamp may be provided by an RFC 3161 compliant independent Time Stamping Authority (TSA). This timestamp token may also be stored in the previously described repository of certification data, associated to the unique identifier of the procedure of signature of the agreement, or in any other data repository.

According to the RFC 3161 standard, a trusted timestamp is a timestamp issued by a trusted third party (TTP) acting as a Time Stamping Authority (TSA). It is used to prove the existence of certain data before a certain point (e.g. contracts, research data, medical records, etc.) whilst preventing anyone from backdating the timestamps. Multiple TSAs can be used to increase reliability and reduce vulnerability.

Once the certification file has been created, processing the certification file to make it available to the parties is required. This way, according to an embodiment, processing the certification file may comprise the following options (obviously other options are possible).

After obtaining identification data of at least one party, said identification data comprising at least one electronic mail address associated to each party (it is not necessary to obtain the electronic mail address of all parties because other options for providing the certification file to the parties are possible), the method may comprise:
Sending an electronic mail message comprising the certification file (e.g. the certification file may be attached to the electronic mail message) to at least one of the obtained electronic mail addresses.

On the other hand, after obtaining identification data of at least one party, said identification data comprising at least an electronic mail address associated to each party, the method may comprise:
Sending an electronic mail message comprising a path for accessing to the certification file to at least one of the obtained electronic mail addresses.

Further, the method may comprise:
Causing the download of the certification file in a computing system associated to each party.

Consequently, the certification file may be made available to the parties in any of the described options. This way, if, for example, the agreement is signed between three parties, one of them may receive the certification file attached to an electronic mail message, another one may receive an electronic mail message with a path or link for accessing the certification file, and the last one may receive the certification file by means of an automatic download in his/her associated computing system; or the three parties may receive an electronic mail message with the certification file attached; or two parties may receive an electronic mail message with the certification file attached and the other one may receive an electronic mail message with a path for accessing to the certification file; and so on. That is, each party may receive the certification file in any of the described options. The selected option for each party may be configured in his/her profile in the system.

In the case of sending an electronic mail message to the parties, the method may comprise:
Receiving an electronic mail message certification file of acceptance or refusal of each sent electronic mail message from the electronic mail servers managing the electronic mail addresses.

This way, it can be easily ensured and certified that the electronic mail message has been delivered to the electronic mail server managing the electronic mail address corresponding to each party.

Further, the method may comprise:
Receiving a timestamp of the generation of the electronic mail message certification file.

Furthermore, the method may comprise:
Storing the received timestamp associated with the generation of the electronic mail message certification file in the previously described repository of certification data, associated to the obtained unique identifier of the procedure of signature, or in any other repository of data.

With reference to the identification data of each party, said obtained identification data of at least one party may be added in the agreement electronic file, before signing said agreement electronic file. Again, this solution improves the certification of the procedure of signature of the agreement because any modification in the identification data of the parties signing the agreement would involve changes in the electronic fingerprint of the agreement electronic file.

According to another embodiment, the method may comprise:
Creating at least one additional electronic file comprising data related to the procedure of signature;
Digitally signing the additional electronic file(s) by generating an electronic fingerprint of said additional electronic file(s).

This way, the certification may provide more information about the procedure of signature of the agreement based on the created additional electronic file and consequently the irrefutable proof of the formalization of the procedure of signature of the agreement becomes stronger.

The additional electronic file may be of different types.

The additional electronic file may be a multimedia file. In this case, the method may comprise:
Receiving multimedia data from at least one party during the procedure of signature;
   wherein creating an additional electronic file comprising data related to the procedure of signature comprises:
Creating at least one multimedia file comprising multimedia data received from at least one party during the procedure of signature, the multimedia file being an additional electronic file.

The multimedia file may comprise any of the following multimedia data:
Audio data captured by a microphone connected to or built-in a computing system associated to at least one party, during the procedure of signature of the agreement electronic file;
Video/audio data captured by a camera and a microphone respectively connected to or built-in a computing system associated to at least one party, during the procedure of signature of the agreement electronic file;
Video data captured by a camera connected to or built-in a computing system associated to at least one party, during the procedure of signature of the agreement electronic file.

Thus, for example, when the procedure of signature starts, the system may issue a request to the parties to use the microphone and/or the camera (e.g. a webcam) associated to the computing system of each party. The computing system of each party that accepts this condition begin to transmit a video and/or an audio signal (multimedia data) to the system, which records them and finally, when the procedure of signature of the agreement is finished, generates a multimedia file for each party. Alternatively or complementarily, a single file comprising all multimedia data received from the parties could be created.

On the other hand, the use of the microphone and/or the camera may be an essential condition for executing the procedure of signature of the agreement.

Another additional electronic file may be a party electronic file. In this case, creating an additional electronic file comprising data related to the procedure of signature may comprise:
Creating a party electronic file comprising the obtained identification data, the party electronic file being an additional electronic file.

The creation of the party electronic file may be complementary or alternative to add the obtained identification data to the agreement electronic file before signing the agreement electronic file as described above.

Furthermore, another additional file may be a text electronic file. In this case, the method may comprise:
Receiving text data from at least one party during the procedure of signature;
   wherein creating an additional electronic file comprising data related to the procedure of signature comprises:
Creating at least one text file comprising text data received from at least one party during the procedure of signature, the text file being an additional electronic file.

The received text data may be, for example, text from a chat established between at least two parties during the procedure of signature of the agreement.

Furthermore, another additional electronic file may be a shared electronic file. In this case, the method may comprise:
Receiving at least one document shared by at least two parties during the procedure of signature of the agreement electronic file;
   wherein creating an additional electronic file comprising data related to the procedure of signature comprises:
Creating a shared electronic file comprising the received document shared by the parties, the shared electronic file being an additional electronic file.

The shared electronic file may comprise any of the following documents (obviously, other documents or data are possible): a file generated by a scanner, a video file, an image file, a text file, a form to be filled in collaboration with other parties, an audio file, or an audio/video file. In summary, the shared electronic file may comprise any document shared between the parties during the procedure of signature of the agreement.

An additional electronic file may also be a content electronic file. In this case, the method may comprise:
Capturing the temporal evolution of the display of a computing system associated to at least one party during the procedure of signature;
   wherein creating an additional electronic file comprising data related to the procedure of signature comprises:
Creating a content electronic file comprising the captured temporal evolution of the display of at least one party, the content electronic file being an additional electronic file.

This way, it is possible to reproduce the variations (e.g. modified elements, deleted elements or added elements in the agreement) in the display (e.g. a screen) associated to the computing system of different parties during the procedure of signature of the agreement when a conflict between parties signing the document arises.

Each party signing the agreement may provide different data for generating additional electronic files. Thus, if there are three parties signing an agreement, all parties may provide multimedia data to the system, which generates a multimedia electronic file for each party, and also one of these parties may share a document with at least another party so that the system must also create a shared electronic file; or each party may provide text data through a chat established between them and one of these parties may also provide multimedia data so that the system must also create a multimedia electronic file; and so on.

When content electronic files are required, it may be suitable to capture the temporal evolution of the display of each party so that, when a verification of the certification is required, the system may display all created content electronic files synchronously.

In any case, as described above, each additional electronic file may be digitally signed by generating an electronic fingerprint of said additional electronic file. As described for the agreement electronic file, said electronic fingerprint may comprise a cryptographic hash value that may be obtained by applying a cryptographic hash function to a consistent version (that is, a format of the additional electronic file that always produces the same hash value when applying the same cryptographic hash function) of the additional electronic file.

In the same way as the agreement electronic file, the method may comprise:
Obtaining a timestamp relating to the procedure of signature of the agreement for the additional electronic file(s);
Adding the obtained timestamp to said additional electronic file(s), before signing said additional electronic file(s).

Once the timestamp is obtained for each additional file, it may be stored in the repository of certification data, associated to the unique identifier of the procedure of signature of the agreement, or in any other repository of data.

Once the electronic fingerprint of each additional electronic file is obtained, the additional electronic files and their associated electronic fingerprints may be added to the certification file previously described or a further certification file may be created. It is important to highlight that a further certification file comprising all the additional electronic files and their associated electronic fingerprints may be created, or a further certification file for each additional electronic file and its associated fingerprint may be created, or at least two further certification files may be created, one of them comprising some additional electronic files and their associated electronic fingerprints and the other one comprising the remaining additional electronic files and their associated electronic fingerprints. In the described last case, the selection of what additional electronic files and their associated electronic fingerprints must be in one further certification file or in the other one may be based in different parameters, for example, the size of the files. That is, it is possible to create a further certification file (or more than one) with a small size that allows sending it by electronic mail message and to create another further certification file (or more than one) with a large size that must be download by the parties (e.g. automatically o through a link or path comprised in an electronic mail message).

Consequently, in the method, creating a certification file (in case the additional files and their associated electronic fingerprints are comprised in the certification file) may comprise:
Giving the additional electronic file(s) a name based on its associated electronic fingerprint;
   wherein the certification file also comprises the additional electronic file(s) and its associated electronic fingerprint as a renamed file(s).

In this case, the certification file may comprise the agreement electronic file and its associated electronic fingerprint as a renamed file or as a packed file and the additional electronic file(s) and its associated electronic fingerprint as a renamed file(s). This way, creating the certification file may comprise packaging the renamed file or the packed file associated to the agreement electronic file and the renamed file(s) associated to the additional electronic file(s).

On the other hand, creating a certification file (in case the additional electronic files and their associated electronic fingerprints are comprised in the certification file) may comprise, after creating a file comprising the electronic fingerprint associated to the additional electronic file, for each additional electronic file:
Creating a packed file comprising the additional electronic file(s) and its associated electronic fingerprint file;
   wherein the certification file also comprises the additional electronic file(s) and its associated electronic fingerprint file as a packed file.

In this case, the certification file may comprise the agreement electronic file and its associated electronic fingerprint as a renamed file or as a packed file and the additional electronic file(s) and its associated electronic fingerprint as a packed file(s). This way, creating the certification file may comprise packaging the renamed file or the packed file associated to the agreement electronic file and the packed file(s) associated to the additional electronic file(s).

Obviously, the certification file may comprise (besides comprising the agreement electronic file and its associated electronic fingerprint as a packed file or as a renamed file) a combination of at least one additional electronic file and its associated electronic fingerprint as a renamed file and at least one additional electronic file and its associated electronic fingerprint as a packed file.

In any case, the further additional electronic file(s) and its associated electronic fingerprint and the certification file may be stored in the repository of certification data, associated to the unique identifier of the procedure of signature of the agreement, or in any other repository of data.

Further, the method may comprise digitally signing the generated certification file. The digital signature may be considered a good way to guarantee the integrity of the content of the certification file. This digital signature may also be stored in the repository, associated to the unique identifier, or in any other repository of data.

Due to the fact that digital signatures are based on cryptographic algorithms that can be broken in the future, the digital signature of a digitally signed file will be considered valid for a limited period of time, after which the signature will expire. This period of time is normally of a few years. In order to keep the digital signature of the certification file in force, some embodiments of the method may comprise periodically digitally signing over the certification file and adding a timestamp to the new digital signature. This periodic signature and timestamp may be generated e.g. a reasonably short time before the expiration of the current signature and related timestamp.

Consequently, by signing the generated certification file and timestamping the generated digitally signed certification file it is possible to prove the content of the agreement electronic file and the additional electronic file(s) in a reliable way and when the whole event took place.

In case of creating at least one further certification file comprising at least one additional electronic file and its associated electronic fingerprint, the creation of said further certification file may comprise:
Giving the additional electronic file(s) a name based on its associated electronic fingerprint;
   wherein the further certification file comprises the additional electronic file(s) and its associated electronic fingerprint as a renamed file(s).

The creation of renamed files must be performed for each additional electronic file and its associated electronic fingerprint. Next, all renamed files may be packed in a file for creating a further certification file or a further certification file may be created for each additional electronic file. Moreover, different further certification files, each comprising a part of the renamed files, may be created.

On the other hand, in case of creating at least one further certification file comprising at least one additional electronic file and its associated electronic fingerprint, the creation of said further certification file may comprise:
Creating a file comprising the electronic fingerprint of the additional electronic file(s);
Creating a packed file comprising the additional electronic file(s) and its associated electronic fingerprint file;
   wherein the further certification file comprises the additional electronic file(s) and its associated electronic fingerprint file as a packed file.

In this case, a further certification file packaging all additional electronic files and their associated electronic fingerprint files may be created. On the other hand, a further certification file (i.e. a packed file) for each additional electronic file and its associated electronic fingerprint file may be created or at least two further certification files (i.e. at least two packed files) may be created, one of them comprising a part of the additional electronic files and their associated electronic fingerprint files and the other one comprising the remaining additional electronic files and their associated electronic fingerprint files.

A further certification file as a packed file, said packed file comprising additional electronic files and their associated electronic fingerprints as renamed files and additional electronic files and their associated electronic fingerprint files as packed files, may be created.

In any case, the further certification file(s), the additional electronic files and their associated electronic fingerprint files may be stored in the repository of certification data, associated to the unique identifier representing the procedure of signature of the agreement, or in any other repository of data.

Once the further certification file(s) is created, it must be made available to the parties. If the parties (at least one of them) provide their electronic mail addresses, then the method may comprise:
Sending an electronic mail message comprising the further certification file to at least one of the obtained electronic mail addresses, and/or
Sending an electronic mail message comprising a path for accessing to the further certification file to at least one of the obtained electronic mail addresses.

If more than one further certification file has been created, an electronic email message comprising all further certification files or an electronic mail message for each further certification file or at least two electronic mail messages, one of them comprising a part of the further certification files and the other one comprising the remaining further certification files, may be sent. On the other hand, a same electronic mail message may comprise the certification file and at least one further certification file.

In case of sending an electronic mail message to the parties, the method may comprise:
Receiving an electronic mail message certification file of acceptance or refusal of each sent electronic mail message from the electronic mail servers managing the electronic mail addresses.

Consequently, the method may also comprise:
Receiving a timestamp of the generation of the electronic mail message certification file, said timestamp being able to be stored in the repository of certification data, associated to the unique identifier of the procedure of signature of the agreement, or in any other repository of data.

According to an embodiment, the method may comprise, if an electronic mail message is not sent to any on the parties:
Causing the download of the further certification file in a computing system associated to each party.

The selection of the option for providing the further certification file to the parties may be performed, for example, according to the size of the further certification file. Thus, a small further certification file may be sent attached to an electronic mail message, whereas a large further certification file may be provided to the parties by means of a link or path comprised in an electronic mail message or causing the download of the further certification file in a computing system associated to each party.

According to another embodiment, the certification file may comprise a summary of the certification of the procedure of signature of the agreement. Thus, said summary may comprise the following information:
The unique identifier of the procedure of signature;
The timestamp relating to the creation of the certification file;
The name assigned to the agreement electronic file;
The identification data of the parties signing the agreement (e.g. name, ID, address, electronic mail address, etc.);
The electronic fingerprint (e.g. a hash value) of the agreement electronic file;
The electronic fingerprints of the additional electronic file.

Said summary of the certification of the procedure of signature of the agreement may be added to the agreement electronic file or may be a different electronic file. In the last case, creating a certification file may comprise:
Creating a packed file comprising the agreement electronic file and its associated electronic fingerprint, and the summary electronic file;
   wherein the certification file comprises the agreement electronic file, its associated electronic fingerprint and the summary electronic file as a packed file.

According to another embodiment, the summary electronic file may be a different file of the certification file, that is, it may be an independent file from the certification file. In this case, said summary electronic file must be made available to the parties in the same way that the certification file (according to the options described above).

On the other hand, if additional electronic files exist and must be comprised in the certification file (not in any further certification file), creating a certification file may comprise:
Creating a packed file comprising the agreement electronic file and its associated electronic fingerprint, the summary electronic file and the additional electronic file(s) and its associated electronic fingerprint;
   wherein the certification file comprises the agreement electronic file and its associated electronic fingerprint, the additional electronic file(s) and its associated electronic fingerprint, and the summary electronic file as a packed file.

The summary electronic file may be also stored in the repository of certification data, associated to the unique identifier, or in any other repository of data.

It is important to highlight that data stored in the repository of certification data may optionally encrypted.

According to another aspect, it is provided a system for certifying a procedure of signature of an electronic file relating to an agreement between at least two parties, the system comprising:
Electronic/computing means for providing an electronic file relating to an agreement between at least two parties;
Electronic/computing means for receiving acceptance data of the agreement from at least one party;
Electronic/computing means for digitally signing the agreement electronic file by generating an electronic fingerprint of said agreement electronic file, when acceptance data of the agreement is received by the receiving electronic/computer means from at least one party;
Electronic/computing means for creating a certification file comprising at least the agreement electronic file and the generated fingerprint of said agreement electronic file;
Electronic/computing means for processing at least the certification file.

It is important to highlight that the electronic/computer means may be used interchangeably, that is, a part of the described means may be electronic means and the other part may be computing means, or all described means may be electronic means or all described means may be computing means.

An example of a system comprising only electronic means may be a CPLD, a FPGA or an ASIC.

In an embodiment, the system may comprise electronic/computer means for connecting the system to a communication network. This connection may be suitable, for example, for obtaining timestamps from a TSA or for providing the certification file and/or the further certification files to the parties.

According to a third aspect, it is provided a computing system comprising a processor and a memory; wherein the memory stores computer executable instructions that, when executed by the processor, cause the computing system to perform a method of certifying a procedure of signature of an electronic file relating to an agreement by at least two parties as described above.

In an embodiment, the computing system may comprise a communication module for connecting the computing system to a communication network.

In another aspect, it is provided a computer program product comprising program instructions for causing a computer to perform a method of certifying a procedure of signature of an electronic file relating to an agreement between at least two parties as described above.

The invention also relates to such a computer program product embodied on a storage medium (for example, a CD-ROM, a DVD, a USB drive, on a computer memory or on a read-only memory) or carried on a carrier signal (for example, on an electrical or optical carrier signal).

Throughout the description and claims the word “comprise” and variations of the word, are not intended to exclude other technical features, additives, components, or steps. Additional objects, advantages and features of the invention will become apparent to those skilled in the art upon examination of the description or may be learned by practice of the invention. The following examples and drawings are provided by way of illustration, and they are not intended to be limiting of the present invention. Reference signs related to drawings and placed in parentheses in a claim, are solely for attempting to increase the intelligibility of the claim, and shall not be construed as limiting the scope of the claim. Furthermore, the present invention covers all possible combinations of particular and preferred embodiments described herein.

### DEFINITIONS

In order to avoid confusions and facilitate understanding of descriptions related to the present invention, this section provides numerous and detailed definitions of key concepts in the context of the present invention.

In the field of the invention, the term “agreement” or “electronic agreement” usually refers to a contract modelled, specified, executed and deployed by a software system. Said type of contracts is conceptually very similar to traditional paper based agreements. Vendors present their products, prices and terms to prospective buyers. Buyers consider their options, negotiate prices and terms where possible, place orders and make payments. Then, the vendors deliver the purchased products. Another example may be that of an employer may make an offer to a potential employee in another country via web-conferencing and the latter accepting the offer. Another example may be a company in Finland negotiating the rights to distribute a movie produced by an Indian company. Another example may be a financial transaction whereby a bank wishes to certify the process of cash withdrawal by a customer from an automated teller machine.

Web-wrap, browse-wrap, click-wrap, click-through, e-contract, e-commerce, e-trade, online agreement, e-agreement, end user license agreements, confidentiality agreements and other contracts which are agreed through an email exchange are different types of electronic agreements which are mostly found on the Internet. In this invention, these terminologies will be used interchangeably to refer to electronic agreements.

The terms “parties” or “signatory parties” usually refers to the legal entities involved in the contract itself. A legal entity is a legal construct through which the law allows a natural person or group of natural persons to act as if they were a single person for certain purposes. The most common purposes are lawsuits, property ownership, and contracts. Some examples of legal entities include: natural persons, companies, corporations, municipalities, natural persons, political parties, states, governments and trade unions among others. There is no limit to the number of signatory parties.

The term “communication network” is a collection of terminals, links and nodes that connect to enable telecommunication between users of the terminals. Each terminal in the network has a unique address so messages or connections can be routed to the correct recipients. Examples of telecommunications networks are computer networks, the Internet, the telephone network, the global Telex network or the aeronautical ACARS network. In this invention, the telecommunication network may only be essential when obtaining a timestamp from a timestamp authority. Furthermore, in this invention, the signing procedure may use a plurality of telecommunications networks in a single session. For instance the two signatory parties may be interacting using computer terminals connected via the Internet as well as having a voice or video conversation using fixed or mobile telephone devices.

The term “agreement electronic file” in the context of this invention usually refers to an electronic file that captures the terms and conditions of the agreement. The agreement is not limited to a text only format and may be, for example, a multimedia file. The agreement most often will be written as a digital document using a computer. However, the agreement electronic file may also be a hand written document that is subsequently scanned into the computer. It may also be an audio or video file in which the terms and conditions of the agreement are only stated or expressed verbally or visually, in the case of using sign language. The multimedia file may optionally be transcribed at a later time or date for ease of reference and future data search. The agreement electronic file may comprise a plurality of multimedia files such as addendums for the purpose of reinforcing or clarifying the terms and conditions of the agreement.

The term “multimedia” may comprise a combination of text, audio, still images, animation, video, rich media or interactivity content forms. Multimedia is usually recorded and played, displayed or accessed by information content processing devices, such as computerized and electronic devices, but can also be part of a live performance. Multimedia devices are electronic media devices used to store and experience multimedia content. The term “rich media” is synonymous for interactive multimedia. Interactive media normally refers to products and services on digital computer-based systems which respond to the user's actions by presenting content such as text, graphics, animation, video, audio, games, etc. Other forms of multimedia content may include, voice or video over Internet Protocol, Instant messaging chat, Short Message Service, Multimedia Messaging Service.

The term “identification data” of a party may comprise entering the signatory's name and passport or national identity number. It may include the scanning and introduction of images of nationally recognised identity documents just showing them to a camera (e.g. a webcam). In an embodiment, the identification data may be a biometric identifier.

Biometric identifiers may be the distinctive, measurable physiological characteristics used to label and describe individuals. Biometrics may be captured with devices such as fingerprint readers, Iris scanners or voice analysers. A physiological biometric would uniquely identify a person by his/her voice, DNA, hand print or behaviour. Behavioural biometrics are related to the behaviour of a person, including but not limited to: typing rhythm, gait, and voice. In an embodiment of the invention, one or more biometric identifiers may be used to authenticate one or more signatories.

In this invention, according to another embodiment, multi-factor authentication may be used to authenticate one or more signatories. Multi-factor authentication is as an approach to security authentication, which requires that the user of a system provide more than one form of verification in order to prove their identity and allow access to the system. Multi-factor authentication takes advantage of a combination of several factors of authentication; three major factors include verification by something a user knows such as a password, something the user has such as a smart card or a security token, and something the user is such as the use of biometrics. Due to their increased complexity, authentication systems using a multi-factor configuration are harder to compromise than ones using a single factor. In this invention, multi-factor authentication may be used as a signature.

A signatory's signature may be in ink on paper which is subsequently scanned and entered into the computer system or an electronic signature comprising a combination of letters, numbers and symbols which the signatory has chosen as his/her personal electronic signature or a unique cryptographically generated digital signature. The signature may also consist of a biometric identifier or a multi-factor authentication data.

The term “display” or “electronic visual display” usually refers to an output device for presentation of information for visual or tactile reception. This way, this output device may be, for example, a screen, a LCD or LED television or similar, an electro-mechanical device for displaying Braille characters, or a volumetric display that form a visual representation of an object in three physical dimensions.

The term “certification” refers to the ability to prove that a procedure of signature of an agreement was performed and when that procedure took place.

The term “certification file” refers to a PDF file (or any other appropriate or equivalent format) that collects information from an agreement electronic file and/or of all additional electronic files related or generated as part of the method in regards to the certification of the procedure of signature of the agreement, and the hash value of any of these additional electronic files and the agreement electronic file.

For legal purposes and as detailed throughout this patent application, this PDF certification file is ultimately digitally signed and time stamped so as to grant the integrity of the data contained on it, reliably set the date when it was created and, finally, enabling to compare the information contained on it with the original data from which this information was obtained and prove the integrity of this original data.

The term “electronic fingerprint” usually refers to the hash value, also known as the message digest or simply digest, that by the means of a cryptographic hash function is obtained from a block of data, also known as the message. As for this patent application, the block of data can be an agreement electronic file or any additional electronic file related or generated as part of the method in regards to a particular certification event.

The term “unique identifier” refers to an identification key in the form of an alphanumeric string that identifies a particular event exclusively, namely a certification event as it results from applying the method, and that for this reason needs to be unique and different from any other identifier. As for this patent application, the unique identifier comprehends not just the event, but also any data and files obtained or generated from that particular event.

### BRIEF DESCRIPTION OF THE DRAWINGS

Particular embodiments of the present invention will be described in the following by way of non-limiting examples, with reference to the appended drawings, in which:

FIG. 1 is a graphic functionally illustrating a suitable architecture for performing embodiments of the method;

FIG. 2 is a flow chart illustrating an embodiment of the method;

FIG. 3 is a flow chart illustrating another embodiment of the method;

FIG. 4 is a flow chart illustrating a further embodiment of the method;

FIG. 5 is a flow chart illustrating a still further embodiment of the method; and

FIG. 6 is a graphic showing some content of an exemplary certification file obtained by performing embodiments of the method.

### DETAILED DESCRIPTION OF EMBODIMENTS OF THE INVENTION

In the following description, numerous specific details are set forth in order to provide a thorough understanding of the present invention. It will be understood by one skilled in the art however, that the present invention may be practiced without some or all of these specific details. In other instances, well known elements have not been described in detail in order not to unnecessarily obscure the description of the present invention.

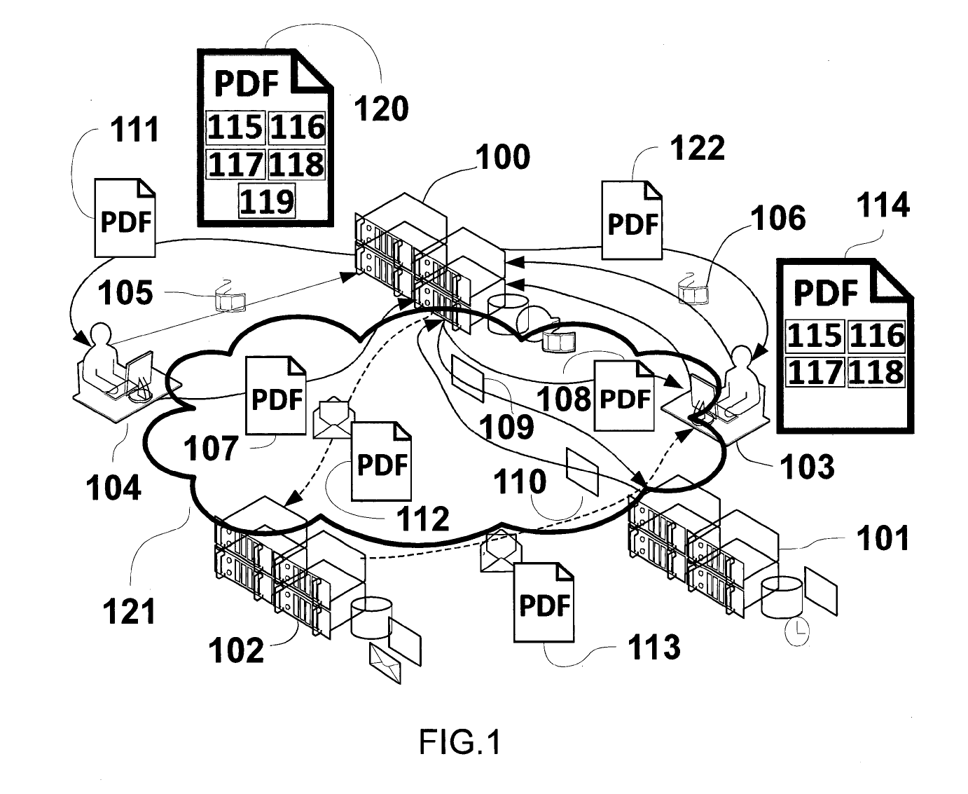

FIG. 1 is a graphic functionally illustrating a suitable architecture for performing embodiments of the method. In this figure, five main systems are shown: a central system according to an embodiment managing the procedure 100 of signature, a Time Stamp Authority system 101, a certified email system 102, an agent (or vendor) computing system 104, and a customer computing system 103. All these systems 100-104 may be connected together by means of a communications network 121, such as e.g. the Internet.

FIG. 1 also shows initiation of a multimedia (e.g. video/audio recording) session 106 from the customer side 103 and initiation of a multimedia (e.g. video/audio recording) session 105 from the agent side 104. This figure also illustrates a transmission of a file 107, such as e.g. a PDF file, containing an agreement to be signed from the agent system 104 to the central system 100, and a transmission of said file containing the agreement to be signed from the central system 100 to the customer system 103, said agreement being displayed in the screen associated to the customer system. This transmission from the agent system 104 to the central system 100 may be performed by e.g. the agent 104 uploading the file to a corresponding web page. This transmission from the central system 100 to the customer system 103 may be performed by e.g. the customer 103 downloading the file from said web page, by streaming and so on.

FIG. 1 also reflects that the customer 103 may input identification data 115-118 into the received file 114, for example, through a form displayed on the screen of the customer system. This identification data may comprise e.g. customer's name 115, customer's tax identifier 116, customer's surname 117, customer's mail address 118, etc. It is further shown in this figure that the central system 100 may request a timestamp 109 to the Time Stamp Authority system 101, said timestamp being accordingly transmitted 110 from the Time Stamp Authority system 101 to the central system 100. Then, the central system 100 may add said timestamp 119 into the file containing the signed agreement and customer's data (certification file) 120.

Still with reference to FIG. 1, it is further shown that the agent or vendor 104 may download 111 the certification file, and also that the customer 103 may download 122 the certification file. Finally, it is shown that the central system 100 may send to the certified email service 102 a request 112 for said certified email service 102 to send the certification file 113 to the customer system 103. Alternatively, the central system 100 may send the certification file via a conventional email server to the customer and/or the agent system, the certified email service 102 certifying that the sent emails has been delivered to the email servers managing the email addresses of the customer and/or the agent.

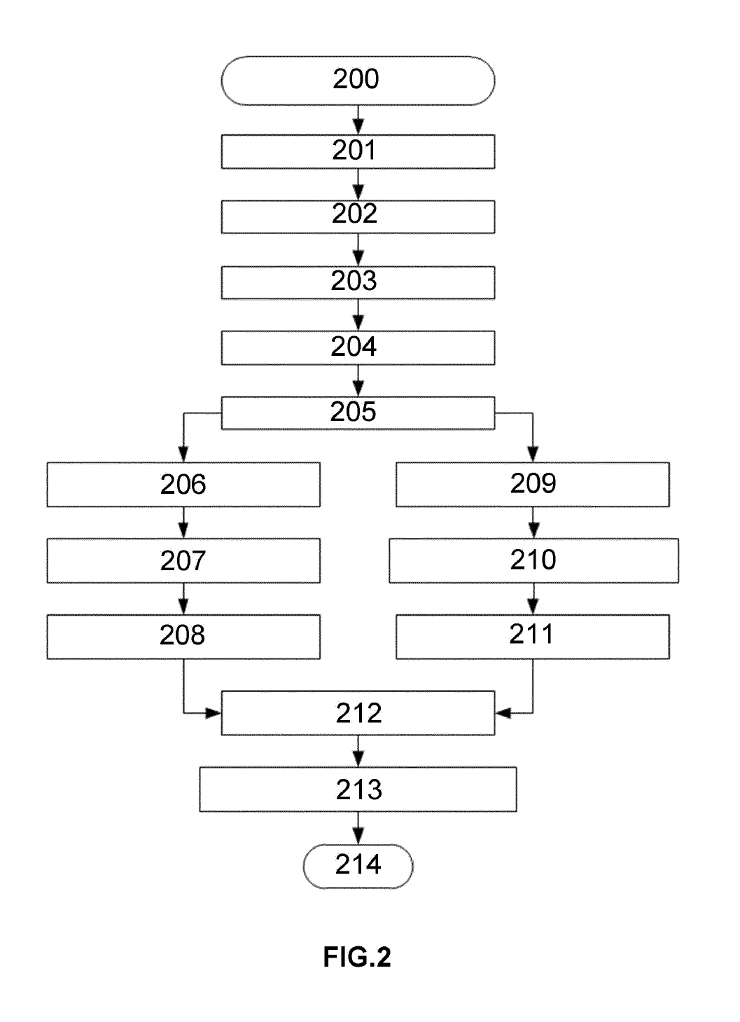

All the transmissions, sending, receptions, uploads, downloads, etc. cited with respect to FIG. 1 will be described in detail in the context of different implementations of the method of certifying a procedure of an agreement signature with reference to FIGS. 2-5.

FIG. 2 is a flow chart illustrating an embodiment of the method. In particular, this figure illustrates an implementation of the method which could be called “assisted signature one-to-one”. This name for this particular implementation refers to an assisted process of electronically signing a contract (or agreement) oriented to e.g. trade operations between two single parties (one-to-one). A first of said parties may be assumed to be one agent or vendor, and a second of said parties may be assumed to be one customer.

In the embodiment of FIG. 2, the method is started at step 200 by the system generating a unique session identifier. Just after, at step 201, the agent may start a session of video and/or audio recording by remotely activating a customer's webcam or prompting the customer to initiate it him/herself. The system may also initiate an active recording of video or image sequence of screenshots or of the screen itself from the customer's browser for the duration of the session. Then, at step 202, the agent may push a document signature button. After this, the customer may choose a corresponding electronic signature and sign the agreement, at step 203. Afterwards, the customer may input, at step 204, identification data, such as e.g. his/her name and surname, a corresponding tax identifier or passport number, and his/her email address. Then, at step 205, a timestamp may be automatically obtained from a Time Stamp Authority.

Once the timestamp has been obtained, two sequences of actions may be performed in parallel, even though said sequences can also be carried out sequentially. A first of the sequences 206-208 may be dedicated to process the contract (or agreement) file, whereas a second of said sequences 209-211 may be in charge of processing any document/file accompanying the signed contract. At step 206, the system may generate an electronic fingerprint (e.g. a hash code) representing the content of the contract, the customer's identification data and the timestamp. This electronic fingerprint may be used by the system, at step 207, to insert the generated hash code to the name of the file containing the contract and customer's identification data. Finally, at step 208, the signed document may be automatically downloaded to the vendor and/or to the customer.

With respect to the sequence of actions aimed at processing files accompanying the contract, an electronic fingerprint (e.g. hash code) of the obtained multimedia files, containing the video and/or audio recorded during the session, may be generated by the system at step 209. Said video/audio recording may be carried out for each attendant (vendor, customer) and both recorded video/audio may be synchronously mixed in a same file. Alternatively or in addition to said video/audio file, other types of supports keeping track of the interaction between both parts may be included in the multimedia files or in any other type of files. Examples of such other supports may be written chats and/or any type of shared documents or applications used during the session and/or the recording of video or image sequence of screenshots or the screen itself. At step 210, the files generated at step 209 may be packed (e.g. compressed) in one common file and the generated hash code may be inserted into the name of said resulting common file. Finally, at step 211, the compressed file may be automatically downloaded to the vendor and/or to the customer.

Once the sequence 206-208 and the sequence 209-211 have been completed, the method continues to step 212, where the system may store the signed document (from sequence 206-208) and the compressed file (from sequence 209-211) into a repository (e.g. database or a directory of folder files) linked to the identifier of the session. Optionally, the signed document may be sent, at step 213, to the customer and/or to the vendor by a certified email service. The method ends at step 214.

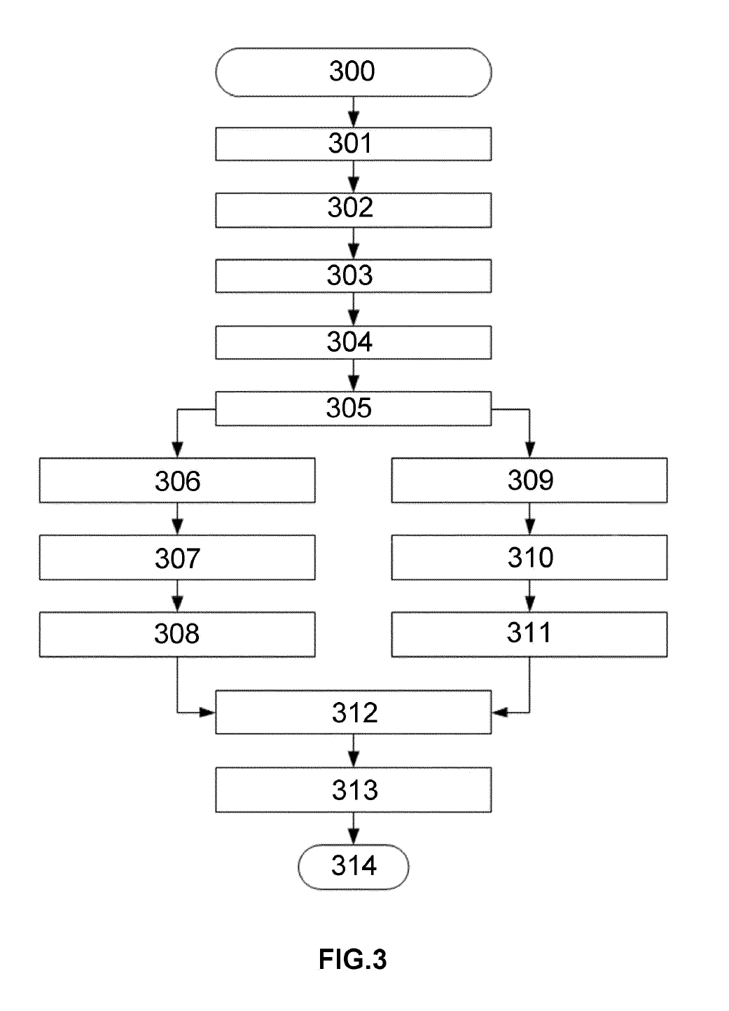

FIG. 3 is a flow chart illustrating another embodiment of the method. In particular, this figure illustrates an implementation of the method which could be called “assisted signature many-to-many”. This name for this implementation refers to a procedure of electronically signing a contract (or agreement) oriented to e.g. trade operations between two parts, each of said parts comprising several (many) participants. Each of said participants will be referred to, in the following description about this figure, as an attendant.

In another embodiment, referred to as many-to-many, the invention is used to record a negotiation process between two or more teams each represented by several agents who are accessing the session from geographically dispersed locations. In this embodiment, the complete negotiation process, the participants identities, the documents exchanged and the text and voice messages exchanged, the final contract and the signatures are all captured by the multimedia recording and similar to previous embodiments, non-repudiable and non-alterable digital certificates of the signing process are produced.

In another embodiment, a two people meeting in a room to sign a property sale contract. They may choose to digitally certify the contract signing process using a computer device. Once the process is initiated by one of the parties, the system generates a unique session number and initiates the multimedia recording session using a web cam and a scanner. In full view of the webcam, the parties are prompted to enter their respective data into the same computing device as well as scanned copies of uniquely identifying personal documents such as a passport or a driver's license. Both candidates sign the paper contract with ink in full view of the webcam and the signed contract is scanned and uploaded into the computer device. The two parties may choose to add their respective digital signatures to the digitally scanned contract. The system then cryptographically binds the contract, identity data and documents and signature to produce a final contract document file which is time stamped with the time obtained from a time stamp authority via the Internet. The multimedia file is also bound with the same session number and cryptographically sealed and time stamped to produce the session multimedia file. The system may generate a certificate of the signing process for each of the parties to retain and for depositing at a Trusted Third Party or at the land registry for recording the certified transaction.

In the embodiment of FIG. 3, the method is started at step 300 by the system generating a unique session identifier. Just after, at step 301, a session of video and/or audio recording may be initiated by remotely activating, for each of the attendants, an attendant's webcam or prompting the attendant to initiate it him/herself. The system may also initiate an active recording of video or image sequence of screenshots or of the screen itself from each attendant's browser for the duration of the session. Then, at step 302, each attendant may push a document signature button. After this, each attendant may choose a corresponding electronic signature and sign the agreement at step 303. Afterwards, each attendant may input, at step 304, identification data, such as e.g. his/her name and surname, a corresponding tax identifier, and his/her email address. Then, at step 305, a timestamp may be automatically required to a Time Stamp Authority.

Once the timestamp has been obtained, two sequences of actions may be performed in parallel for each attendant, even though said sequences can also be carried out sequentially. A first of the sequences 306-308 may be dedicated to process the contract (or agreement) file, whereas a second of said sequences 309-311 may be in charge of processing any document/file accompanying the signed contract. At step 306, the system may generate an electronic fingerprint (e.g. hash code) representing the content of the contract, the attendant's identification data and the timestamp. This electronic fingerprint may be used by the system, at step 307, to insert the generated hash code to the name of the file containing the contract and attendant's identification data. Finally, at step 308, the signed document may be automatically downloaded to each attendant.

With respect to the sequence of actions aimed at processing files accompanying the contract, an electronic fingerprint (e.g. hash code) of the obtained multimedia files, containing the video and/or audio recorded during the session, may be generated by the system at step 309. Said video/audio recording may be carried out for each attendant and both recorded video/audio may be synchronously mixed in a same file. Alternatively or in addition to said video/audio file, other types of supports keeping track of the interaction between the attendants may be included in the multimedia files or in any other type of files. Examples of such other supports may be written chats and/or any type of shared documents or applications used during the session and/or the recording of video or image sequence of screenshots or of the screen itself. At step 310, the files generated at step 309 may be packed (e.g. compressed) in one common file and the generated hash code may be inserted into the name of said resulting common file. Finally, at step 311, the compressed file may be automatically downloaded to each attendant.

Once the sequence 306-308 and the sequence 309-311 have been completed, the method continues to step 312, where the system may store the signed document (from sequence 306-308) and the compressed file (from sequence 309-311) into a repository (e.g. database or a directory of folder files) linked to the identifier of the session. Optionally, the signed document may be sent, at step 313, to each attendant by a certified email service. The method ends at step 314.

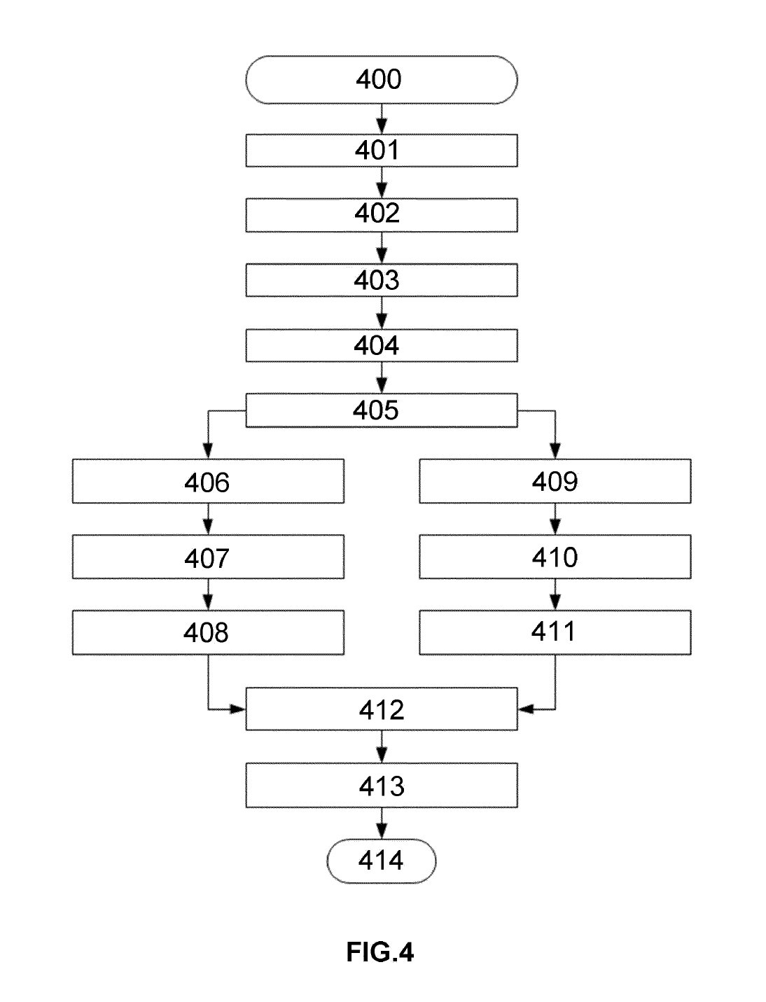

FIG. 4 is a flow chart illustrating an embodiment of the method. In particular, this figure illustrates an implementation of the method which could be called “assisted signature one-to-many”. This name for this particular implementation refers to an assisted procedure of electronically signing a contract (or agreement) oriented to e.g. trade operations between a first single part (one) and a second part including several participants (many). Said first part may be assumed to be one agent or vendor. Each of the participants of the “many” part will be referred to, in the following description about this figure, as an attendant.

In another embodiment, a university teacher delivering a distance-learning course over the Internet. The university wishing to retain proof of delivery of the course on the Internet may choose to initiate a one-to-many digital signing process certification. In this embodiment the students are accessing the live tuition of the teacher through the web browser of their personal computer systems in different geographic locations. Once a session is initiated by the teacher, a unique session number is generated and the multimedia recording is initiated at each terminal connected to this teaching session. Multimedia recording devices may include, web cam, Internet voice recorder, voice or video over Internet Protocol recorder, browser based collaborative computer program among others. The computer program that controls the computer devices and their peripherals may be embedded in each computer device or may be embedded in the cloud and only activated as a service. The teacher and the students are invited to present themselves by entering their unique personal data and presenting additional identity documents or biometrics if required. The system may authenticate the identities simultaneously by comparing the data to the student registration database. In this embodiment the signing certification process records the conversations, interactions, tuition materials presented by the teacher either as a live performance or as uploaded documents. The interaction of the teacher and the students takes place across multiple multimedia channels which are captured simultaneously by the multimedia recording devices. At the end of the session, the students are invited to evaluate the tuition received and sign to confirm receipt of the course. In this embodiment, the evaluation form presented by each participant is cryptographically bound to the respective signatory's signature and identification data and documents. The sealed document file is time stamped. The multimedia recordings which include the complete course as well as the process of signing the evaluation form are terminated and each user's file is cryptographically sealed and time stamped.

In the embodiment of FIG. 4, the method is started at step 400 by the system generating a unique session identifier. Just after, at step 401, the agent may cause initiation of a session of video and/or audio recording by remotely activating, for each of the attendants, an attendant's webcam or prompting the attendant to initiate it him/herself. The system may also initiate an active recording of video or image sequence of screenshots or of the screen itself from each attendant's browser for the duration of the session. Then, at step 402, the agent may push a document signature button. After this, each attendant of the “many” part may choose a corresponding electronic signature and sign the agreement at step 403. Afterwards, each attendant of the “many” part may input, at step 404, identification data, such as e.g. his/her name and surname, a corresponding tax identifier, and his/her email address. Then, at step 405, a timestamp may be automatically required to a Time Stamp Authority.

Once the timestamp has been obtained, two sequences of actions may be performed in parallel for each attendant of the “many” part, even though said sequences can also be carried out sequentially. A first of the sequences 406-408 may be dedicated to process the contract (or agreement) file, whereas a second of said sequences 409-411 may be in charge of processing any document/file accompanying the signed contract. At step 406, the system may generate an electronic fingerprint (e.g. hash code) representing the content of the contract, the attendant's identification data and the timestamp. This electronic fingerprint may be used by the system, at step 407, to insert the generated hash code to the name of the file containing the contract, the attendant's identification data and the timestamp. Finally, at step 408, the signed document may be automatically downloaded to the agent and/or to each attendant of the “many” part.

With respect to the sequence of actions aimed at processing files accompanying the contract, an electronic fingerprint (e.g. hash code) of the obtained multimedia files, containing the video and/or audio recorded during the session, may be generated by the system at step 409. Said video/audio recording may be carried out for the agent and each attendant of the “many” part and each recorded video/audio may be synchronously mixed in a same file. Alternatively or in addition to said video/audio file, other types of supports keeping track of the interaction between both parts (agent and attendants of the “many” side) may be included in the multimedia files or in other type of files. Examples of such other supports may be written chats and/or any type of shared documents or applications used during the session, and/or the recording of video or image sequence of screenshots or of the screen itself. At step 410, the files generated at step 409 may be packed (e.g. compressed) in one common file and the generated hash code may be inserted into the name of said resulting common file. Finally, at step 411, the compressed file may be automatically downloaded to the agent and/or to each attendant of the “many” side.

Once the sequence 406-408 and the sequence 409-411 have been completed, the method continues to step 412, where the system may store the signed document (from sequence 406-408) and the compressed file (from sequence 409-411) into a repository (e.g. database or a directory of folder files) linked to the identifier of the session. Optionally, the signed document may be sent, at step 413, to the agent and/or to each attendant of the “many” side by a certified email service. The method ends at step 414.

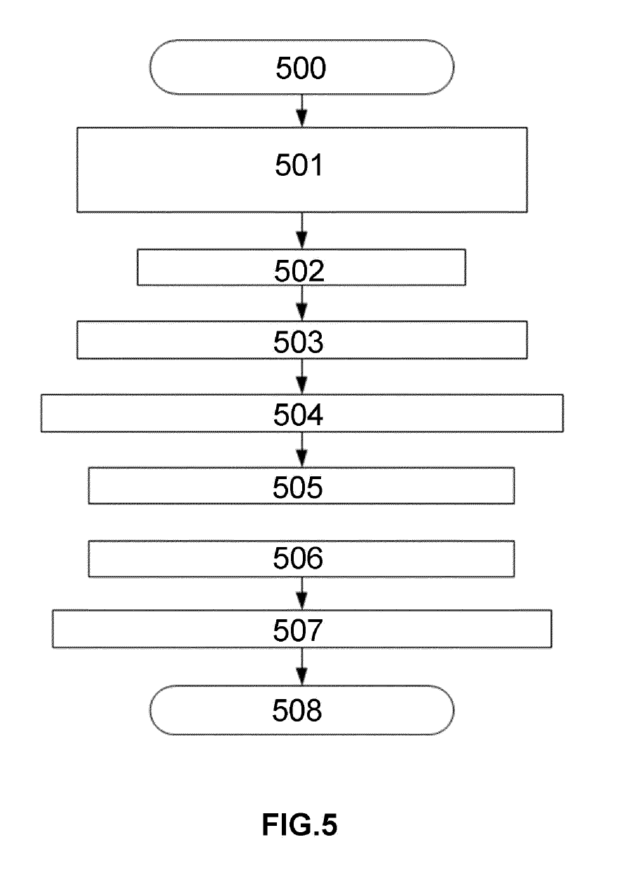

FIG. 5 is a flow chart illustrating a still further embodiment of the method. In particular, this figure illustrates an embodiment of the method which could be called non-assisted signature. The following description about this FIG. 5 will be expressed by assuming that two parts are involved, a vendor and a customer.

In this example, the method starts at step 500 by the system generating a unique session identifier. After, at step 501, a tag may be inserted in one page of a website. The tag may work like a button and may include, among other features, the contract (or agreement) to be signed and a form. The form may include several fields aimed at recording signer's data. The structure of the form may be managed by the vendor from a Web back-office. The contract (or agreement) may be uploaded and managed also by the vendor from the Web back-office. Optionally, the system may initiate at least one multimedia recording session by remotely activating a customer's webcam or prompting the customer to initiate it him/herself. The system may also initiate an active recording of video or image sequence of screenshots or of the screen itself from the customer's browser for the duration of the session.

Next, at step 502, the customer may press the button to open the contract (or agreement), even though the contract may not be edited. Then, at step 503, the form to register signer's data may be displayed once the customer has pushed the sign button. This form may include, among other fields, the following basic signer's fields: name, surname, e-mail, identification number. The system may also initiate a series of audio questions via an automated interactive voice emanating from the web browser prompting the customer to respond to questions. Once the form has been filled out and/or questions have been responded the system may add, at step 504, a timestamp delivered by a Time Stamp Authority to the basic fields and automatically generate an electronic fingerprint (e.g. hash code) representing the contract along with the added data.

Then, the method may continue to step 505, where the system may add the generated digital signature (electronic fingerprint) to the contract as a new last page, which produces a certification file. The system may rename this certification file by including the digital signature in its name. Optionally, the system may compress the certification file. Next, at step 506, the system may automatically store this certification file into a repository (e.g. database), in the Web back-office, linked to the univocal identifier of the session, and may download the certification file to the customer. Optionally, at step 507, the resulting certification file may be automatically sent by a certified email service. This exemplary method ends at step 508.

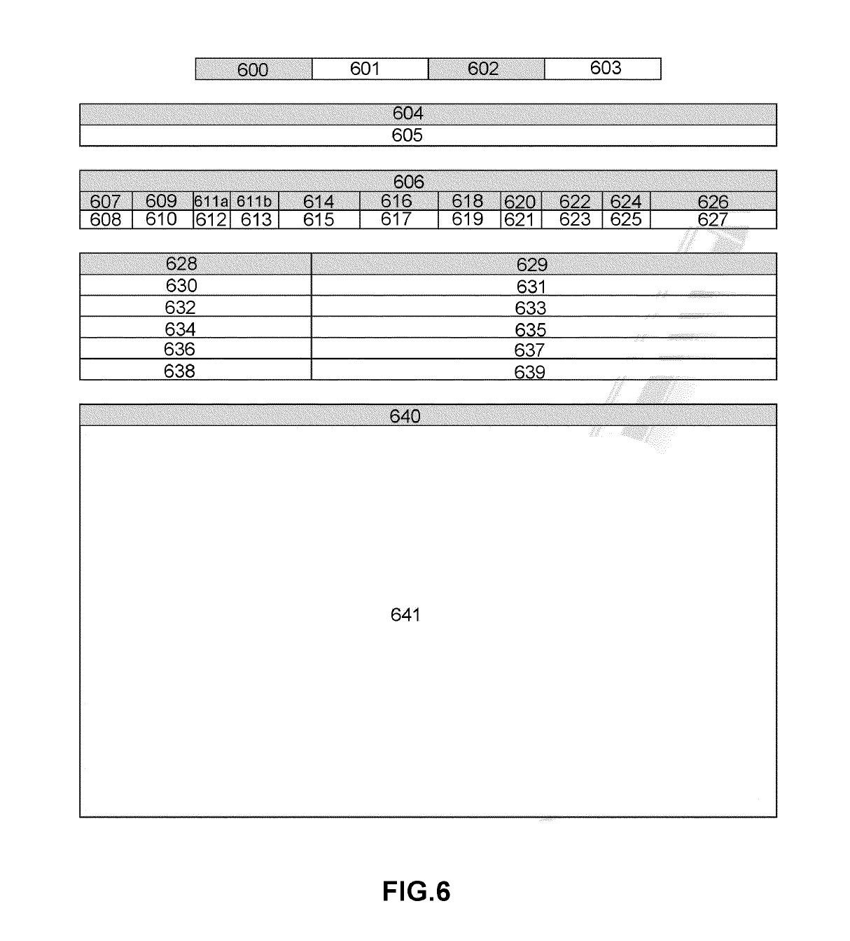

FIG. 6 schematically shows some content of an exemplary certification file obtained by performing embodiments of the method. This schema just refers to a last page of a certification file and shows several different parts summarizing the content of the certification file. A first part corresponds to cells 600-603, wherein the cell 600 contains a label (e.g. “session number”) indicating the content of its related cell 601, which contains the session number uniquely identifying the performed session of electronic signature (e.g. “2A333z1”), and the cell 602 contains a label (e.g. “date of signature delivered by a TSA (Time Stamp Authority)”) indicating the content of its related cell 603, which contains the date at which the electronic signature was carried out (e.g. “28/01/2013 16:51:51”).

A second part corresponds to cells 604-605, wherein the cell 604 contains a label (e.g. “name of the signed document or documents”) indicating the content of its related cell 605, which contains the name of the signed document or documents (e.g. “TermsAndConditions.pdf”).

A third part of the schema corresponds to cells 606-627, wherein the cell 606 contains a label (e.g. “signatory or signatories data”) indicating the content of its related cells 607-627, which contain corresponding particular labels and data about the signatory or signatories. The cell 607 may contain a label (e.g. “Name”) indicating that its related cell 608 contains the signatory's name (e.g. “Jose”). The cell 609 may contain a label (e.g. “Surname”) indicating that its related cell 610 contains the signatory's surname (e.g. “Lopez”). The cell 611a may contain a label (e.g. “Age”) indicating that its related cell 612 contains the signatory's age (e.g. “40”). The cell 611b may contain a label (e.g. “Marital status”) indicating that its related cell 613 contains the signatory's marital status (e.g. “Married”). The cell 614 may contain a label (e.g. “Nationality”) indicating that its related cell 615 contains the signatory's nationality (e.g. “Spanish”). The cell 616 may contain a label (e.g. “Identifier”) indicating that its related cell 617 contains the signatory's identification number (e.g. “58974362K”). The cell 618 may contain a label (e.g. “Address”) indicating that its related cell 619 contains the signatory's address (e.g. “C/ Mayor 1”). The cell 620 may contain a label (e.g. “Postcode”) indicating that its related cell 621 contains the signatory's postcode (e.g. “08024”). The cell 622 may contain a label (e.g. “City”) indicating that its related cell 623 contains the signatory's city (e.g. “Barcelona”). The cell 624 may contain a label (e.g. “Country”) indicating that its related cell 625 contains the signatory's country (e.g. “Spain”). The cell 626 may contain a label (e.g. “Email”) indicating that its related cell 627 contains the signatory's email (e.g. “jose.lopez@somemail.com”).

A fourth part corresponds to cells 628-639, wherein the cell 628 contains a label (e.g. “Element”) indicating the content of its related cells 630, 632, 634, 636 and 638, each of which may contain the name of an element (e.g. file) produced during the signature process, and the cell 629 contains a label (e.g. “electronic fingerprint”) indicating the content of its related cells 631, 633, 635, 637 and 639, each of which may contain an electronic fingerprint attributed to its related element. For example: the cell 630 may contain the element “signed document” and the cell 631 may contain the hash code attributed to the signed document, the cell 632 may contain the element “audio-visual recording of agent” and the cell 633 may contain the hash code attributed to said recording, the cell 634 may contain the element “audio-visual recording of customer” and the cell 635 may contain the hash code attributed to said recording, the cell 636 may contain the element “shared contents” and the cell 637 may contain the hash code attributed to said shared contents, and the cell 638 may contain the element “shared chat” and the cell 639 may contain the hash code attributed to said shared chat.

The fifth and last part corresponds to cells 640-641, wherein the cell 640 contains a label (e.g. “Informative note”) indicating the content of its related cell 641, which may contain information about the content of the previously described parts (first to fourth part). The cell 641 may contain information about the overall content of the certification file, such as e.g. which technique/function has been used to obtain hash codes, whether the documents have been compressed or not, which technique/process has been used to achieve said compression, etc.

Although only a number of particular embodiments and examples of the invention have been disclosed herein, it will be understood by those skilled in the art that other alternative embodiments and/or uses of the invention and obvious modifications and equivalents thereof are possible. Furthermore, the present invention covers all possible combinations of the particular embodiments described. Thus, the scope of the present invention should not be limited by particular embodiments, but should be determined only by a fair reading of the claims that follow.

Further, although the embodiments of the invention described with reference to the drawings comprise computer apparatus and processes performed in computer apparatus, the invention also extends to computer programs, particularly computer programs on or in a carrier, adapted for putting the invention into practice. The program may be in the form of source code, object code, a code intermediate source and object code such as in partially compiled form, or in any other form suitable for use in the implementation of the processes according to the invention. The carrier may be any entity or device capable of carrying the program.

For example, the carrier may comprise a storage medium, such as a ROM, for example a CD ROM or a semiconductor ROM, or a magnetic recording medium, for example a floppy disc or hard disk. Further, the carrier may be a transmissible carrier such as an electrical or optical signal, which may be conveyed via electrical or optical cable or by radio or other means.

When the program is embodied in a signal that may be conveyed directly by a cable or other device or means, the carrier may be constituted by such cable or other device or means.

Alternatively, the carrier may be an integrated circuit in which the program is embedded, the integrated circuit being adapted for performing, or for use in the performance of, the relevant processes.

1. A method of certifying a procedure of signature of an electronic file relating to an agreement between at least two parties, the method comprising:
Providing an electronic file relating to an agreement between at least two parties; when acceptance data of the agreement is received from at least one party:
Digitally signing the agreement electronic file by generating an electronic fingerprint of said agreement electronic file;
Creating a certification file comprising at least the agreement electronic file and the generated electronic fingerprint of said agreement electronic file;
Processing at least the certification file;
Creating at least one additional electronic file comprising data related to the procedure of signature;
Digitally signing the additional electronic file(s) by generating an electronic fingerprint of said additional electronic file(s).

2. (canceled)

3. The method according to claim 1, wherein creating a certification file comprises:
Giving at least one of the agreement electronic file or the additional electronic file(s) a name based on its associated electronic fingerprint;
and wherein the certification file comprises at least one of the agreement electronic file or the additional electronic file(s) and its associated electronic fingerprint as a renamed file(s).

4. The method according to claim 3, wherein processing at least the certification file comprises:
Storing the certification file in a repository, associated to a unique identifier of the procedure of signature.

5. The method according to claim 1, further comprising:
Creating a file comprising the electronic fingerprint of at least one of the agreement electronic file or the additional electronic file(s).

6. The method according to claim 5, further comprising:
Storing at least one of the agreement electronic file or the additional electronic file(s) and its associated electronic fingerprint file in a repository, associated to a unique identifier of the procedure of signature.

7. The method according to claim 5, wherein creating a certification file comprises:
Creating a packed file comprising at least one of the agreement electronic file or the additional electronic file(s) and its associated electronic fingerprint file;
and wherein the certification file comprises at least one of the agreement electronic file or the additional electronic file(s) and its associated electronic fingerprint file as a packed file.

8. The method according to claim 7, wherein processing at least the certification file comprises:
Storing the certification file in a repository, associated to a unique identifier of the procedure of signature.

9. The method according to claim 1, further comprising:
Obtaining a timestamp relating to the procedure of signature of the agreement for at least one of the agreement electronic file or the additional electronic file(s);
Adding the obtained timestamp to said electronic file(s), before signing said electronic file(s).

10. The method according to claim 9, further comprising:
Storing the obtained timestamp(s) in a repository, associated to a unique identifier of the procedure of signature.

11. The method according to claim 1, further comprising:
Creating a further certification file comprising the additional electronic file(s) and its associated electronic fingerprint.

12. The method according to claim 11, wherein creating a further certification file comprises:
Giving the additional electronic file(s) a name based on its associated electronic fingerprint;
and wherein the further certification file comprises the additional electronic file(s) and its associated electronic fingerprint as a renamed file(s).

13. The method according to claim 11, wherein creating a further certification file comprises:
Creating a file comprising the electronic fingerprint of the additional electronic file(s);
Creating a packed file comprising the additional electronic file(s) and its associated electronic fingerprint file;
and wherein the further certification file comprises the additional electronic file(s) and its associated electronic fingerprint file as a packed file.

14. The method according to claim 11, further comprising:
Storing, the further certification file in a repository, associated to a unique identifier of the procedure of signature.

15. The method according to claim 11, further comprising:
Obtaining identification data of at least one party;
Adding the obtained identification data in the agreement electronic file, before signing said agreement electronic file.

16. The method according to claim 11, further comprising:
Obtaining identification data of at least one party;
and wherein creating an additional electronic file comprising data related to the procedure of signature comprises:
Creating a party electronic file comprising the obtained identification data, the party electronic file being an additional electronic file.

17. The method according to claim 15, wherein the obtained identification data comprises, for each party, at least an electronic mail address.

18. The method according to claim 17, wherein processing at least the certification file comprises:
Sending an electronic mail message comprising at least one of the certification file or the further certification file to at least one of the obtained electronic mail addresses.

19. The method according to claim 17, wherein processing at least the certification file comprises:
Sending an electronic mail message comprising a path for accessing to at least one of the certification file or the further certification file to at least one of the obtained electronic mail addresses.

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. A computer program product comprising program instructions for causing a computer to perform a method of certifying a procedure of signature of an electronic file relating to an agreement between at least two parties according to claim 1.

33. (canceled)

34. (canceled)

35. A system for certifying a procedure of signature of an electronic file relating to an agreement between at least two parties, the system comprising:
Electronic/computer means for providing an electronic file relating to an agreement between at least two parties;
Electronic/computer means for receiving acceptance data of the agreement from at least one party;
Electronic/computer means for digitally signing the agreement electronic file by generating an electronic fingerprint of said agreement electronic file, when acceptance data of the agreement is received by the receiving electronic/computer means from at least one party;
Electronic/computer means for creating a certification file comprising at least the agreement electronic file and the generated fingerprint of said agreement electronic file;
Electronic/computer means for processing at least the certification file.

36. (canceled)

37. (canceled)

38. (canceled)
